(19) United States
(12) Patent Application Publication
(10) Pub. No.: US 2019/0031546 A1
(43) Pub. Date: Jan. 31, 2019

(54) ATMOSPHERIC WATER GENERATION SYSTEM USING MULTI-STAGE FILTRATION AND METHOD OF FORMING SAME

(71) Applicant: Aldelano IP Holdings, LLC, Ontario, CA (US)

(72) Inventors: Alfred Hollingsworth, Ontario, CA (US); Nicole Smith, Grand Rapids, MI (US); Michael Goodwyn, Jackson, TN (US); Nicholos Rakestraw, Jackson, TN (US)

(21) Appl. No.: 16/148,694

(22) Filed: Oct. 1, 2018

Related U.S. Application Data
(63) Continuation of application No. PCT/US2017/025716, filed on Apr. 3, 2017.
(60) Provisional application No. 62/317,155, filed on Apr. 1, 2016.

(51) Int. Cl. C02F 9/00; E03B 3/28

(52) U.S. Cl. CPC C02F 9/00; C02F 1/004; E03B 3/28

(57) ABSTRACT

An atmospheric water generation system includes an atmospheric water generator (AWG) (100) having a holding tank (117) using first ultraviolet (UV) light (119) for disinfecting water in the holding tank (117). A pump (121) for transporting the water from the holding tank (117) to a multi-stage water filter (123) wherein such water filter comprises in-seriatim; a sediment filter (203), at least one carbon block filter (205, 207), a granular activated carbon filter (209), a second UV light (211) and a re-mineralization filter (213).

### FIELD OF THE INVENTION

The present invention relates generally to atmospheric water generation and more particular to a solar powered AWG using multi-stage UV filtration.

### BACKGROUND

Traditional water generation system work to filter and purify tap and well water. Bottled water can be overpriced, cumbersome and difficult to store. A third source of water is from an atmospheric water generator (AWG). An AWG is a new, state of the art system that takes humidity from the air to produce pure drinking water. The AWG operates by extracting humidity from the air and then converting it into potable drinking water. The AWG is typically a humidity and temperature driven, self-contained unit, making water from air. It can generate gallons of water per day depending on the specific atmospheric conditions. In underdeveloped nations, this technology can help to meet the growing demand for economical, good tasting and quality drinking water. Atmospheric water generation is a green friendly, alternative source, for users who wish to maintain control over their own water supply.

The capacity of the atmospheric water generator relies on the level of humidity in the air which generally must be in excess of 30% and the temperature. The Atmospheric Water Generator water is treated with ozone for clean and pure water production along with multiple filters to ensure every drop stays fresh and clean for human consumption. No longer must persons in remote areas rely on municipal water systems or the transportation and storage of bottled water. Those in need, in any region or the world with adequate humidity, can have constant access to clean drinking water.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is block diagram illustrating the water generation system according to various embodiments of the invention.

FIG. 2 is a block diagram of the water filtration system as used with the water generator illustrated in FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an atmospheric water generator. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

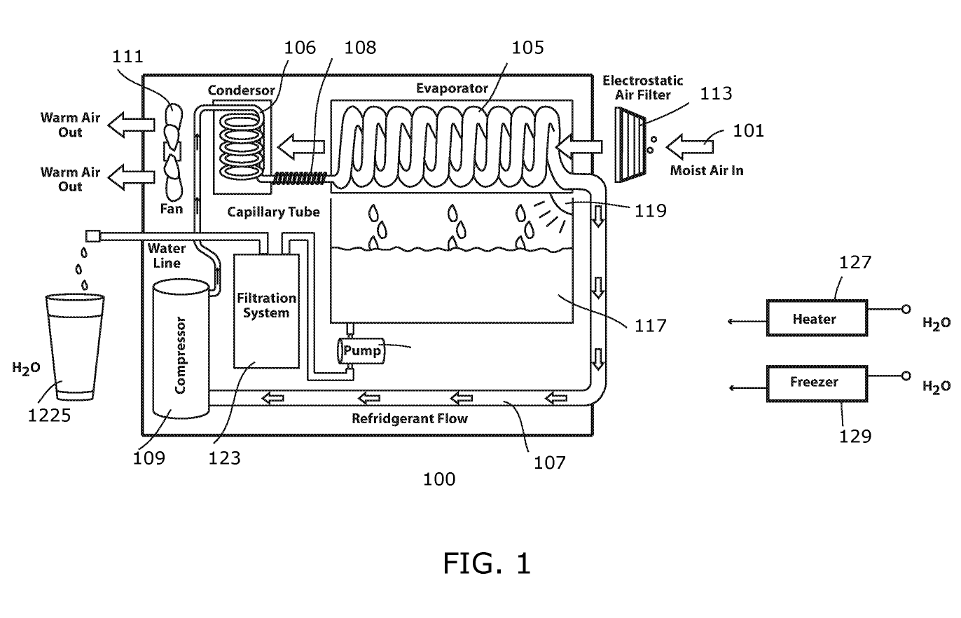

FIG. 1 is block diagram illustrating an atmospheric water generator with heating and ice capability according to an embodiment of the invention. An atmospheric water generator (AWG), is a device that extracts water from moist ambient air. Water vapor in the air is condensed by cooling the air below its dew point, exposing the air to desiccants, or pressurizing the air. Unlike a dehumidifier, an AWG is designed to render the water potable. Because there is almost always a small amount of water in the air that can be extracted, AWGs are useful where safe drinking water is difficult or impossible to obtain. Hence, research has developed AWG technologies to produce useful yields of water at a reduced energy cost.

Many atmospheric water generators operate in a manner very similar to that of a dehumidifier where air is passed over a cooled coil which causes the water to condense. The rate upon which water is produced depends on many factors including the air's ambient temperature, humidity, the volume of air passing over the coil, and the machine's capacity to cool the coil. In operation, these systems typically reduce air temperature, which in turn reduces the air's capacity to carry water vapor. This is the most common technology in use, but when powered by typical electrical systems can demand a lot of energy for water production.

As seen in FIG. 1, a cooling condensation type atmospheric water generator 100 operates in a manner where moist air 101 is filtered 103 through and electrostatic filter or the like. This air is passed over an evaporator 105 and on to a condenser coil 106. The air exits the water generator using a fan 111. Air passing over the evaporator 105 causes condensation that is collected by a holding tank 117. Water falls by gravity from the evaporator 105.

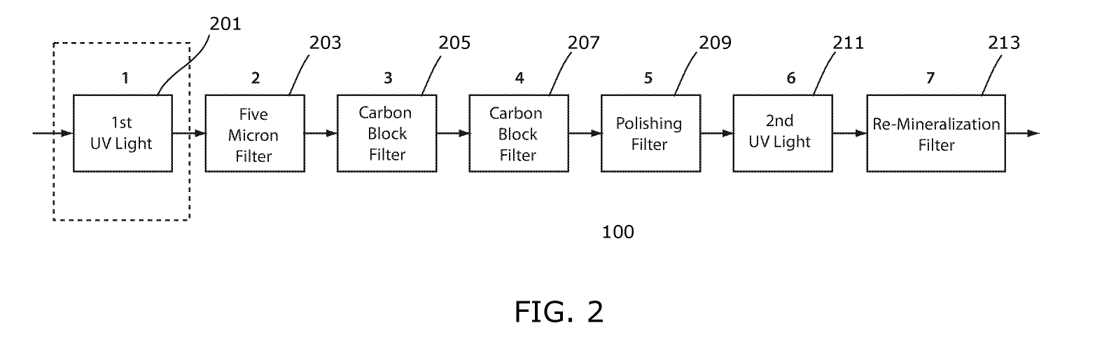

In order to make the water safe to drink, the water in the holding tank 117 is initially cleansed using a first UV light 119. The first UV light is positioned at a predetermined position within the tank so that the ultraviolet light rays can reach the surface of the stored water to kill any bacteria or protozoa. After exposure to UV, the water is pumped using an electric pump 121 from the holding tank 117 to a multi-stage filtration system 123. The multistage filtration system 123 is described in more detail with regard to FIG. 2 and includes a plurality of differing filter types connected serially i.e. in series or in-seriatim. After making its way through the multistage filtration system 123, the water 125 is clean and potable where it can be used for drinking or the like.

The process for condensing the water present in the air involves the use of a compressor 109. The compressor 109 is typically electrically powered and circulates refrigerant (such as Freon or the like) in pipe 107 through a condenser 106. The condenser 106 connects with evaporator 105 through a capillary tube 108. It is the evaporator coil 105 that cools the air surrounding it. This lowers the air's temperature to its dew point, causing water in the air to condense. A controlled-speed fan 111 forces filtered air over the evaporator coil 105. As noted above, the resulting potable water is then passed into the holding tank 117 where a purification and filtration system, such at first UV light 119 keep the water clean and free of bacteria. The first UV light 119 reduces the risk posed by viruses and bacteria which may be collected from the ambient air on the evaporator coil by the condensing water.

The rate at which water can be produced depends on relative humidity and ambient air temperature and size of the compressor and evaporator. Atmospheric water generators become more effective as relative humidity and air temperature increase. As a rule of thumb, cooling condensation atmospheric water generators do not work efficiently when the temperature falls below 18.3° C. (65° F.) or the relative humidity drops below 30%. This means they are relatively inefficient when located inside air-conditioned offices. The cost-effectiveness of an AWG depends on the capacity of the machine, local humidity and temperature conditions and the cost to power the unit. Once potable water is produced, the water can be heated using a heating unit 127 or alternatively can be frozen to produce ice using a freezing unit 129. Those skilled in the art will recognize that the process of refrigeration involves a compressor heating the refrigerant to create a hot gas that is sent to the condenser which cools the gas to a liquid. During this process, heat is expelled around the condensing coil that can be captured and used in connection with a heat exchanger. The heat exchanger can then be used to heat the potable water prior to the heat being expelled from the system.

Further, a temperature sensor can be inserted in the condensing coil that will turn the compressor off when the coil temperature gets close to predetermined temperature such as freezing. Variable speed technology can be used to vary the compressor fan speed to maintain the condensing coil at a specific temperature. Optimally, this temperature is slightly above freezing but always below the dew point. This allows the water generator to operate in marginal conditions regardless of the environment. Moreover, the dew point can be calculated allowing the water generation unit to operate only when it is practical, regardless of the climate or geographic location of the refrigeration unit. Further, the refrigeration unit uses software that can “learn” when the most moisture is available in a 24 hour period and maximize its water production during that time period.

In another embodiment, the cool air from the unit's evaporator can move past the condenser such that the air volume through both of these coils can be independently varied using only one blower. This enables more water to be produced at lower power consumption with less stress on the unit's compressor. A highly efficient, variable speed blower motor can be used with software control.

FIG. 2 is a block diagram of a multi-stage water filtration system as used with the water generator illustrated in FIG. 1. The multi-stage water filtration system 200 receives water from a first UV light 201 located within a holding tank as described herein. After being pumped from the holding tank the water is sent though piping to a sediment filter 203. Although many sizes are available, a sediment filter that can strain particles at least 5 micron in size is typically used. The filter is a cartridge type filter that can easily be removed and replaced. Those skilled in the art will recognize that virtually all cartridge-style sediment filters follow a “radial flow” pattern. In a radial flow design, water flows through the wall of the filter into the inner core. This arrangement provides a filtering surface that consists of the entire length and circumference of the cartridge. Filters can be configured as “depth” filters or “pleated” filters although pleated filters offer more filtering surface area. Although water filters can have many purposes, the sediment filter 203 is intended to remove suspended solids, variously referred to as turbidity, sediment or particulate rather then metallic contaminants, “dissolved solids” chemicals and/or charged particles.

After leaving the sediment filter 203, the water is directed though a first carbon block filter 205. The first carbon block filter 205 acts to reduce any chlorine taste and/or odor. Carbon block filters contain pulverized activated carbon that is shaped into blocks under high pressure. The filter is typically more effective than granulated activated carbon filters because it has more surface area. The effectiveness of the first carbon block filter 205 depends in part on the rate upon which water flows through it. Thereafter, the water is directed to a second carbon block filter 207 for added protection and improvement of taste and odor.

After exiting the second carbon block filter 207, water is directed to a granular activated carbon final polishing filter 209. Granulated activated carbon filters contain fine grains of activated carbon. They are typically less effective than carbon block filters because they have a smaller surface area of activated carbon. Its effectiveness in enhancing taste also depends on how quickly water flows though the filter.

Upon exiting the polishing filter 209, water is then directed to a second UV light filter 211. UV light filtration is very effective as it takes approximately 90 seconds to purify 32 fl. oz. of water with most UV purifiers. No wait time is needed before drinking once the water has been exposed to UV light for the appropriate amount of time. A number of factors combine to make UV radiation a superior means of water purification for rainwater harvesting systems. Ultraviolet radiation is capable of inactivating all types of bacteria. Additionally, ultraviolet radiation disinfects rapidly without the use of heat or chemical additives which may undesirably alter the composition of water.

The ultraviolet spectrum includes wavelengths from 2000 to 3900 Angstrom units (Å). One unit is one ten billionth of a meter. The 2000 to 3900 Å range is typically divided into three segments namely:
a) Long-wave ultraviolet—The wavelength range is 3250 to 3900 Å. These rays occur naturally in sunlight and have little germicidal value;
b) Middle-wave ultraviolet—The wavelength range is 2950 to 3250 Å, also found in sunlight and is best known for its sun-tanning effect. It provides some germicidal action, with sufficient exposure; and
c) Short-wave ultraviolet—The wavelength range is 2000 to 2950 Å where this segment possesses by far the greatest germicidal effectiveness of all ultraviolet wavelengths. It is employed extensively to destroy bacteria, virus, mold, spores, etc., both air- and water-borne. Short-wave ultraviolet does not occur naturally at the earth's surfaces, as the earth's atmosphere screens out sunlight radiation below 2950 Å.

In order to take practical advantage of the germ-killing potential of short-wave ultraviolet, it is necessary to produce this form of energy through the conversion of electrical energy. The conversion of electrical energy to short-wave radiant ultraviolet is accomplished in a mercury vapor lamp or UV light emitting diode (LED).

After being cleansed by the second UV light 211, the water may also be sent though a re-mineralization filter 213. The purpose of the re-mineralization filter 213 is to add natural calcium and magnesium minerals to the water giving it a better taste.

In still other embodiments, the refrigeration system and the water treatment/storage system may be two separate units where the refrigeration portion of the unit is a separate “self-contained” unit. The water generator might be built from lightweight aluminum with handles on both sides so it can be easily transported or moved. It can then be placed on an elevated platform. This would allow the water it produces to gravity flow (without the need for a pump) into a self-contained” holding tank and treatment system at a lower level. This water could then be pumped through a filtration and sterilization system into a holding tank. In still embodiments, the refrigeration and water generation units can vary in capacity so as to match the “available” electrical power stored in batteries, when full power is not available.

Thus, the present invention is directed to a solar powered atmospheric water generation unit utilizing a multi-stage water filtration system. More specifically, the water filtration system includes two UV light devices, a sediment filter, two carbon block filters, a polishing filter and a re-mineralization filter. The use of the multi-filtration system with the AWG insures clean and good tasting potable water at locations were municipal water or well water is not possible.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An atmospheric water generation system comprising:
an atmospheric water generator (AWG);
a holding tank having a first ultraviolet (UV) light for disinfecting water in the holding tank;
a pump for transporting the water from the holding tank to a multi-stage water filter wherein such water filter comprises in-seriatim:
a sediment filter;
at least one carbon block filter;
a granular activated carbon filter;
a second UV light; and
a re-mineralization filter.

2. An atmospheric water generation system as in claim 1, wherein sediment filters sediment over 5 microns in size.

3. An atmospheric water generation system as in claim 1, wherein the at least one carbon block filter is comprised of two in-series carbon block filters for improving taste and removing odor.

4. An atmospheric water generation system as in claim 1, wherein the first UV light and second UV light are light emitting diodes (LEDs) for conserving energy.

5. An atmospheric water generation system as in claim 1, wherein the atmospheric water generation system is solar powered.

6. A solar powered atmospheric water generation system comprising:
an atmospheric water generator (AWG) utilizing an evaporator coil to produce water from the air;
a holding tank positioned below the evaporator coil to collect the water;
a first UV light positioned within the holding tank to kill bacteria and protozoa in the water;
a multistage filtration system for receiving water from the holding tank and cleaning the water of particulate matter, where the multi-stage filtration system includes a plurality of filters configured in-series and a second UV light positioned downstream of the plurality of filters for cleansing the water before consumption.

7. A solar powered atmospheric water generation system as in claim 6, wherein plurality of filters include at least one sediment filter, a plurality of carbon block filters and a granular activated carbon filter.

8. A solar powered atmospheric water generation system as in claim 7, further comprising a re-mineralization filter configured after the second UV filter for adding minerals to the water to enhance taste.

9. A method for forming an atmospheric water generation system comprising:
providing an atmospheric water generator (AWG);
configuring a holding tank having a first ultraviolet (UV) light for disinfecting water in the holding tank;
utilizing a pump for transporting the water from the holding tank to a multi-stage water filter wherein such water filter is configured in-seriatim; a sediment filter; at least one carbon block filter; a granular activated carbon filter; a second UV light; and a re-mineralization filter.

10. An atmospheric water generation system as in claim 9, further comprising the step of:
configuring the sediment filters such that it filters particulates over 5 microns in size.

11. An atmospheric water generation system as in claim 10, further comprising the step of:
configuring the at least one carbon block filter such that it is comprised of a first carbon block filter and a second carbon block filter for improving taste and removing odor.

12. An atmospheric water generation system as in claim 9, further comprising the step of:
configuring the first UV light and second UV light such that they are light emitting diodes (LEDs) for conserving energy.

13. An atmospheric water generation system as in claim 9, further comprising the step of:
configuring the water generation system so that it is solar powered.
